(19) United States
(12) Patent Application Publication
(10) Pub. No.: US 2014/0132092 A1
(43) Pub. Date: May 15, 2014

(54) ROTATING ELECTRICAL MACHINE

(71) Applicant: NIPPON PISTON RING CO., LTD., Saitama-shi (JP)

(72) Inventors: Masafumi SAKAMOTO, Shimotsuga-gun (JP); Shigeyoshi SATO, Shimotsuga-gun (JP); Shunsuke TAKEGUCHI, Shimotsuga-gun (JP)

(73) Assignee: NIPPON PISTON RING CO., LTD., Saitama-shi (JP)

(21) Appl. No.: 14/076,458

(22) Filed: Nov. 11, 2013

(30) Foreign Application Priority Data
Nov. 14, 2012 (JP) 2012-250053

(51) Int. Cl. H02K 37/12

(52) U.S. Cl. CPC H02K 37/125
USPC 310/49.34

(57) ABSTRACT

A rotating electrical machine having high efficiency and torque, in which the stator is provided with a stator core including an annular yoke portion and n winding poles radially extending from the annular yoke portion, the rotor core includes a circumference portion having small teeth substantially in parallel with the rotary shaft, and an end surface portion having small teeth substantially perpendicular to the rotary shaft, the circumference portion of the winding pole in the stator and the circumference portion of the rotor core in the rotor face each other via an air gap to provide a radial gap, and the end surface portion of the winding pole in the stator and the end surface portion of the rotor core in the rotor face each other via an air gap to provide an axial gap, and n is an integer of 2 or more.

### BACKGROUND OF THE INVENTION

1. Field of the Invention

The present invention relates to a rotating electrical machine, such as a small electric motor and generator.

2. Description of the Related Art

In the market, there has been a strong demand for miniaturization and thinning of rotating electrical machines which are small-sized to medium-sized electric motors or generators having output power of about 1 kW or less. Further, in recent years, high-efficiency and energy-saving electric motors have been required as a global warming countermeasure. Also, in generators, as a result of reviewing the use of natural energy as an alternative of nuclear power, the demand for a small wind power generator for home use has also been growing. In the case of wind power generation, the rotational speed of a wind turbine is low, and hence the rotational speed is increased by gears, and the like, so as to rotate a generator. Further, lower cost is also strongly demanded from the market. Therefore, for use in such applications, multipolar permanent magnet type generators have been attracting attention. One of the forms of such rotating electrical machines is a hybrid-type stepping motor (hereinafter abbreviated as HBSTM). Also, the demand for HBSTMs has been increasing because of its original function of facilitating the positioning control, and because of its use as a so-called direct drive motor which is a multi-pole synchronous motor (of about 100 poles) having low speed and high torque characteristics and which can eliminate the use of a mechanical moderator by taking advantage of the characteristics. However, further improvements in torque and efficiency have been required because of the above-described reasons.

The rotating electrical machine is classified into a radial gap type rotating electrical machine and an axial gap type rotating electrical machine. The radial gap type rotating electrical machine has been widely used as a general purpose machine because of the advantages that the size of air gap can be reduced, and that the area facing the air gap can be increased in the rotary shaft direction of the rotating electrical machine. Further, the axial gap type rotating electrical machine, which is formed to have a thin shape, is advantageous for obtaining higher output power as compared with the radial gap type rotating electrical machine. Therefore, the axial gap type rotating electrical machine has been used in applications and fields in which a rotating electrical machine having a special shape is required. However, because of the above-described reasons, further improvements in torque and efficiency have been required for both the radial gap type rotating electrical machine and the axial gap type rotating electrical machine.

Rotating electrical machines are disclosed, for example, in “Method for Using Stepping Motor” (written by Masafumi Sakamoto, published by Ohmsha, Ltd.) p 44, FIG. 2.32.

### SUMMARY OF THE INVENTION

In order to improve torque and efficiency characteristics of an HBSTM, it is effective to reduce the air gap g between the stator and the rotor or to increase the facing area S between the stator teeth and rotor teeth. The permeance P of the air gap between the stator teeth and rotor teeth is expressed by the following expression (1) in which μ₀ is permeability of vacuum.

P=μ₀S/g (1)

That is, torque and efficiency characteristics of HBSTMs can be improved by increasing the permeance P. However, in the case of HBSTMs, the air gap g is already as small as about 0.05 mm, and hence it is difficult to further reduce the air gap g.

As a device for further reducing the air gap g of HBSTMs, there is an inner spigot structure of a rotating electrical machine, as illustrated in the right figure of FIG. 2.32 of “Method for Using Stepping Motor” described above. The structure shown in this figure adopts a structure, referred to as an “inner spigot” structure, in which a part of each of front and rear brackets is not fitted into a part of an outer peripheral portion of the stator but is directly fitted into a part of an inner peripheral portion of the stator to guide to secure the air gap. This figure discloses front and rear brackets, a stator configured by a laminated portion of silicon steel sheets and a winding provided at the laminated portion, and a rotor inserted into the stator. In such structure in which the stator is formed by laminating silicon steel sheets, even when the air gap is set to about 0.05 mm, the air gap can be sufficiently secured in mass production. Such structure has been widely adopted for HBSTMs. However, as can be seen from the right figure of FIG. 2.32 of “Method for Using Stepping Motor”, the structure has a problem that, since the length of the rotor in the rotary shaft direction becomes shorter than the lamination length of the stator, the stator cannot be effectively used over the entire lamination length of the stator, and hence the facing area S of the air gap portion is reduced. This results in a problem that the permeance P expressed by expression (1) is not increased so much. FIG. 10 and FIG. 11 in this application are views corresponding to the prior art described above.

The present invention is realized by the following devices. Note that the components for realizing the following devices are respectively denoted by reference numerals for reference purposes, but are not limited to these denoted by the reference numerals.

“Device 1”

A rotating electrical machine including a stator (100), a rotor (200), and a rotary shaft (10), the rotating electrical machine being realized by a device wherein:

the stator (100) is provided with a stator core (1) including an annular yoke portion (110) and n winding poles (120) radially extending from the annular yoke portion (110), and a winding (4) concentrically wound around each of the winding poles (120);

a winding axis of the winding (4) is perpendicular to the rotary shaft (10);

the stator core (1) is divided into two portions each having a thickness substantially half the thickness of the stator core (1) in a rotary shaft direction, and is also circumferentially divided into n portions each including each of the winding poles (120);

each of the n winding poles (120) includes, at a distal end portion (121) thereof, a circumference portion (122) having small teeth substantially in parallel with the rotary shaft, and an end surface portion (123) having small teeth substantially perpendicular to the rotary shaft;

the rotor (200) includes a permanent magnet (8) magnetized in the rotary shaft direction, and two rotor cores (7) holding the permanent magnet therebetween;

the rotor core (7) includes a circumference portion (72) having small teeth substantially in parallel with the rotary shaft (10), and an end surface portion (73) having small teeth substantially perpendicular to the rotary shaft;

the circumference portion (122) of the winding pole (120) in the stator (100) and the circumference portion (72) of the rotor core (7) in the rotor (200) face each other via an air gap to provide a radial gap, and the end surface portion (123) of the winding pole (120) in the stator (100) and the end surface portion (73) of the rotor core (7) in the rotor (200) face each other via an air gap to provide an axial gap; and

n is an integer of 2 or more.

“Device 2”

The rotating electrical machine as described in “device 1”, the rotating electrical machine being realized by a device wherein:

brackets (5, 6) and bearings (9) are provided on an outer side of the rotor (200) in the rotary shaft direction; and

in a state where the stator core (1) is divided into n portions, the winding (4) is concentrically wound around each of the winding poles (120), and the divided portions of the stator core (1) are combined and assembled with each other by being inserted from the outer side in the direction perpendicular to the rotary shaft by using the brackets (5, 6) and the bearings (9) as guides.

“Device 3”

A rotating electrical machine including a stator (300), a rotor (200), and a rotary shaft (10), the rotating electrical machine being realized by a device wherein:

the stator (300) includes a stator core (14) provided with an annular yoke portion (15) and n winding poles (120) radially extending in a state of being in contact with an inner circumference of the annular yoke portion (15), and a winding (4) concentrically wound around each of the winding poles (120);

a winding axis of the winding (4) is perpendicular to the rotary shaft (10);

the stator core (14) is divided, except the annular yoke portion (15), into two portions each having a thickness substantially half the thickness of the stator core (14) in a rotary shaft direction and is also circumferentially divided into n portions each including each of the winding poles (120);

each of the n winding poles (120) includes, at a distal end portion (121) thereof, a circumference portion (122) having small teeth substantially in parallel with the rotary shaft, and an end surface portion (123) having small teeth substantially perpendicular to the rotary shaft;

the rotor (200) includes a permanent magnet (8) magnetized in the rotary shaft direction, and two rotor cores (7) holding the permanent magnet therebetween;

the rotor core (7) includes a circumference portion (72) having small teeth substantially in parallel with the rotary shaft (10), and an end surface portion (73) having small teeth substantially perpendicular to the rotary shaft;

the circumference portion (122) of the winding pole (120) in the stator (300) and the circumference portion (72) of the rotor core (7) in the rotor (200) face each other via an air gap to provide a radial gap, and the end surface portion (123) of the winding pole (120) in the stator (300) and the end surface portion (73) of the rotor core (7) in the rotor (200) face each other via an air gap to provide an axial gap; and

n is an integer of 2 or more.

“Device 4”

The rotating electrical machine as described in “device 3”, the rotating electrical machine being realized by a device wherein:

brackets (17) and bearings (9) are provided on an outer side of the rotor (200) in the rotary shaft direction; and

in a state where the stator core (14), except the annular yoke portion (15), is divided into n portions, the winding (4) is concentrically wound around each of the winding poles (120), and the divided portions of the stator core (14) are combined and assembled with each other in such a manner that the divided portions are assembled from the outer side in the direction perpendicular to the rotary shaft and the annular yoke portion (15) is successively inserted from the rotary shaft direction by using the brackets (17) and the bearings (9) as guides.

“Device 5”

The rotating electrical machine as described in one of “device 1” to “device 4”, the rotating electrical machine being realized by a device wherein:

a rotary-shaft-direction thickness of a groove for winding in each of the winding poles (120) of the stator (100, 300) is reduced from a center toward an outer side of the stator (100, 300).

“Device 6”

A rotating electrical machine including a stator (400), a rotor (200), and a rotary shaft (10), the rotating electrical machine being realized by a device wherein:

the stator (400) is provided with two stator cores (18) each including a disk-like yoke portion (410) and n winding poles (420) extending from the disk-like yoke portion (410) in parallel with the rotary shaft (10), and a winding (19) concentrically wound around each of the winding poles (420), and is configured by combining the two stator cores (18) with each other in a state where the winding poles (420) face each other in a rotary shaft direction;

a winding axis of the winding (19) is in parallel with the rotary shaft (10);

each of the two stator cores (18) has a thickness substantially half the thickness of the stator (400) in the rotary shaft direction;

each of the n winding poles (420) includes, at a distal end portion (120) thereof, a circumference portion (422) having small teeth substantially in parallel with the rotary shaft (10), and an end surface portion (423) having small teeth substantially perpendicular to the rotary shaft (10);

the rotor (200) includes a permanent magnet (8) magnetized in the rotary shaft direction, and two rotor cores (7) holding the permanent magnet (8) therebetween;

the rotor core (7) includes a circumference portion (72) having small teeth substantially in parallel with the rotary shaft (10), and an end surface portion (73) having small teeth substantially perpendicular to the rotary shaft;

the circumference portion (122) of the winding pole (420) in the stator (400) and the circumference portion (72) of the rotor core (7) in the rotor (200) face each other via an air gap to provide a radial gap, and the end surface portion (123) of the winding pole (420) in the stator (400) and the end surface portion (73) of the rotor core (7) in the rotor (200) face each other via an air gap to provide an axial gap; and

n is an integer of 2 or more.

“Device 7”

The rotating electrical machine as described in one of “device 1” to “device 6”, the rotating electrical machine being realized by a device wherein:

the stator core (1, 14, 18) is configured by a dust core or a sintered core.

“Device 8”

The rotating electrical machine as described in one of “device 1” to “device 7”, the rotating electrical machine being realized by a device wherein:

the rotor core (7) is configured by a dust core or a sintered core.

“Device 9”

The rotating electrical machine as described in one of “device 7” and “device 8”, the rotating electrical machine being realized by a device wherein:

the dust core or the sintered core configuring one of or both of the stator core (1, 14, 18) and the rotor core (7) is subjected to one of or both of resin coating treatment and resin impregnation treatment.

(1) A portion facing an air gap is provided at the axial gap portion in addition to the radial gap portion. Therefore, even when, due to the elimination of the inner spigot structure, the air gap length is slightly increased as compared with the prior art, the increase in the area of the portion facing the air gap is much larger, and hence the torque can be significantly increased.

(2) The rotary-shaft-direction thickness of the groove portion of the core of the winding portion is reduced from the center toward the outer side of the stator core, so that the space factor of the winding can be further increased, and hence the efficiency of the rotating electrical machine can be improved.

(3) The stator is configured by split cores, so that the winding space factor can be significantly improved, and hence higher torque can be obtained.

(4) A dust core is used, and thereby it is possible to obtain a highly efficient rotating electrical machine which has almost no eddy current loss and in which in particular, the iron loss at the time of high speed rotation is small.

(5) In the case of the present invention in which the winding axis is set in parallel with the rotary shaft direction, the outer diameter of the permanent magnet can be increased, and hence the interlinkage magnetic flux can be increased, which is advantageous for obtaining higher torque.

### BRIEF DESCRIPTION OF THE DRAWINGS

FIG. 1 is a cross-sectional view showing a rotating machine of an example of the present invention and including the rotary shaft of the rotating machine;

FIG. 2 is a cross-sectional view of the rotating machine seen from the rotary shaft direction in FIG. 1;

FIG. 3 is a view of a rotor of the present invention seen from the rotary shaft direction;

FIG. 4 is a view of the rotor seen from the opposite side in the rotary shaft direction in FIG. 3;

FIG. 5 is a cross-sectional view showing another rotor of the present invention and including the rotary shaft;

FIG. 6 is a cross-sectional view showing a rotating machine of another example of the present invention and including the rotary shaft of the rotating machine;

FIG. 7 is a cross-sectional view of the rotating machine seen from the rotary shaft direction in FIG. 6;

FIG. 8 is a cross-sectional view showing a rotating machine of yet another example of the present invention and including the rotary shaft of the rotating machine;

FIG. 9 is a cross-sectional view of the rotating machine seen from the rotary shaft direction in FIG. 8;

FIG. 10 is a view showing a prior art; and

FIG. 11 is a cross-sectional view along the line XI-XI shown in FIG. 10.

### DETAILED DESCRIPTION OF THE PREFERRED EMBODIMENTS

In the following, embodiments according to the present invention will be described with reference to the accompanying drawings.

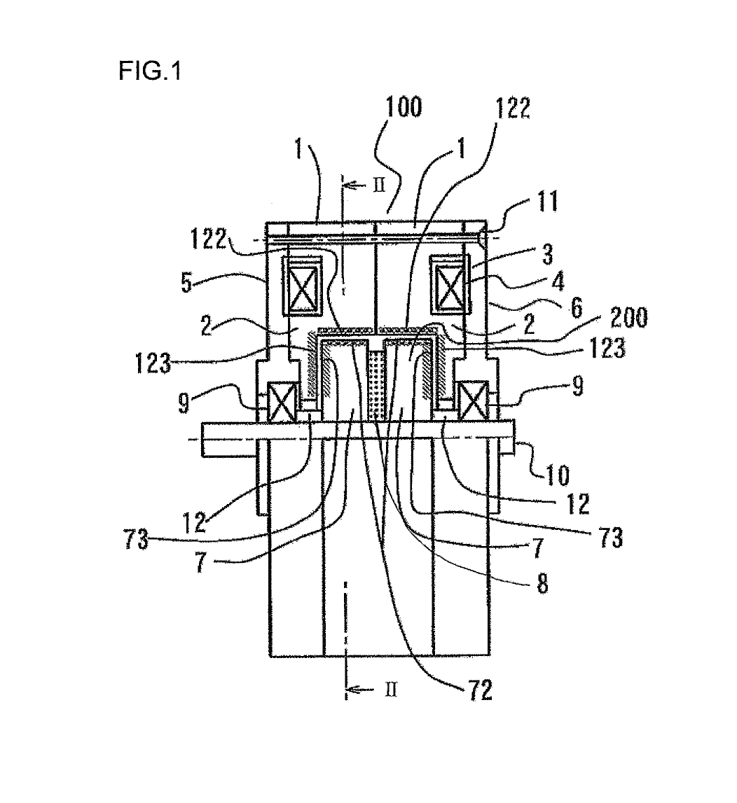

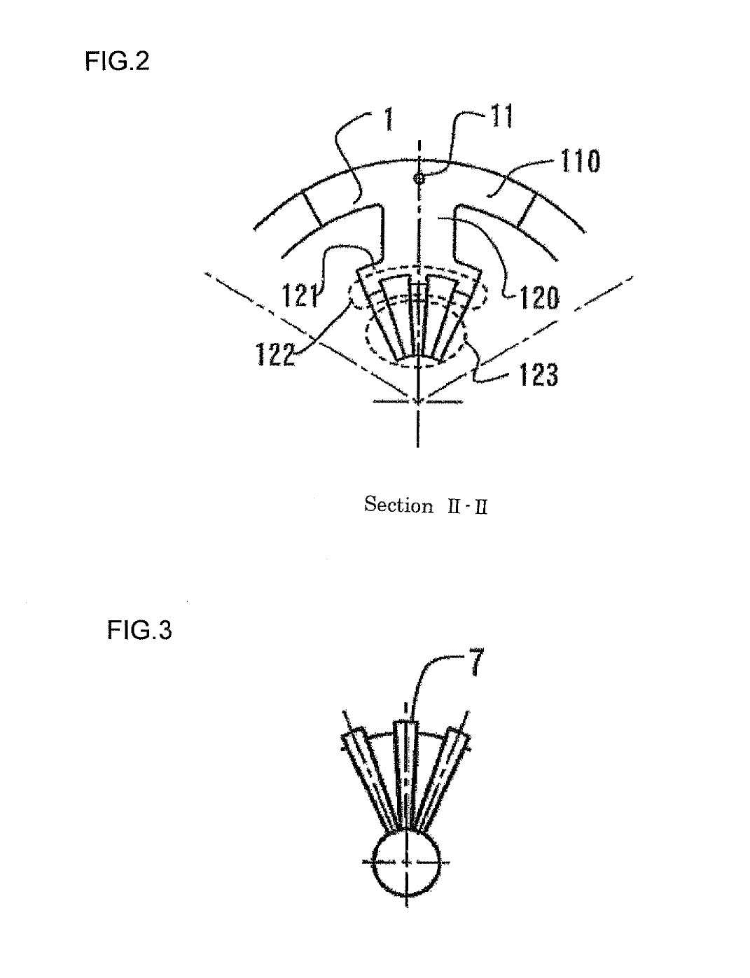

FIG. 1 shows an example of a configuration according to the present invention, and is a cross-sectional view showing an HBSTM according to the present invention and including the rotary shaft of the HBSTM. FIG. 2 is a view of the HBSTM seen from the rotary shaft direction in FIG. 1 and is a cross-sectional view along the line II-II in FIG. 1.

In FIG. 1 and FIG. 2, reference numeral 1 denotes a stator core formed of a dust core or a sintered core. The stator core 1 according to the present invention is configured in such a manner that the stator core 1 is divided into two portions each having a thickness of half the thickness of the stator core 1 in the rotary shaft direction, and that the divided two portions are combined with each other. As for the left half of the stator core 1 in FIG. 1, the stator core 1 is a core formed of a dust core, a sintered core, or the like, and is configured, as shown in FIG. 2, by an annular yoke portion 110, n winding poles 120 radially extending from the annular yoke portion 110, and a winding 4 concentrically wound around each of the winding poles 120. The winding pole 120 includes, at a distal end portion 121 thereof, a circumference portion 122 having small teeth substantially in parallel with the rotary shaft, and an end surface portion 123 having small teeth substantially perpendicular to the rotary shaft. On the other hand, a rotor 200 includes a permanent magnet 8 magnetized in the rotary shaft direction, and two rotor cores 7 holding the permanent magnet 8 therebetween. The rotor core 7 includes a circumference portion 72 having small teeth substantially in parallel with the rotary shaft 10, and an end surface portion 73 having small teeth substantially perpendicular to the rotary shaft. Further, the HBSTM according to the present invention is configured such that the circumference portion 122 of the winding pole 120 in the stator 100 and the circumference portion 72 of the rotor core 7 in the rotor 200 face each other via an air gap to provide a radial gap, and such that the end surface portion 123 of the winding pole 120 in the stator 100 and the end surface portion 73 of the rotor core 7 in the rotor 200 face each other via an air gap to provide an axial gap. That is, in the HBSTM according to the present invention, the stator and the rotor, each having the teeth, face each other in both the radial and axial directions.

Reference numeral 3 denotes an insulator, such as resin. Each of reference numerals 5 and 6 denotes a bracket made of an aluminum material, or the like, and serves to secure the air gap between the rotor core 7 and the stator core 1 via a bearing 9. Each of the brackets 5 and 6 is provided with a cylindrical portion formed concentrically to an inner diameter portion into which the bearing 9 is fitted. The outer diameter portion of the cylindrical portion of each of the brackets 5 and 6 is fitted with the inner diameter portion of a flange-like guide portion denoted by reference numeral 2, so that the air gap is secured. Reference numeral 8 denotes the permanent magnet, such as a neodymium magnet, magnetized in the rotary shaft direction. In the conventional HBSTM, the magnetic field of the permanent magnet in the rotary shaft direction is bent into the direction perpendicular to the rotary shaft direction, so as to pass through the air gap in the radial direction. In this way, in the HBST, the permanent magnet is magnetized in the rotary shaft direction, and hence the magnetic flux of the permanent magnet easily leaks in the rotary shaft direction. The present invention is featured in that the magnetic field in the rotary shaft direction is also effectively utilized. Reference numeral 10 denotes the rotary shaft. Reference numeral 11 denotes a bolt. The brackets 5 and 6 are tightened and fixed to each other by the bolts 11 so as to hold the stator core 1 therebetween.

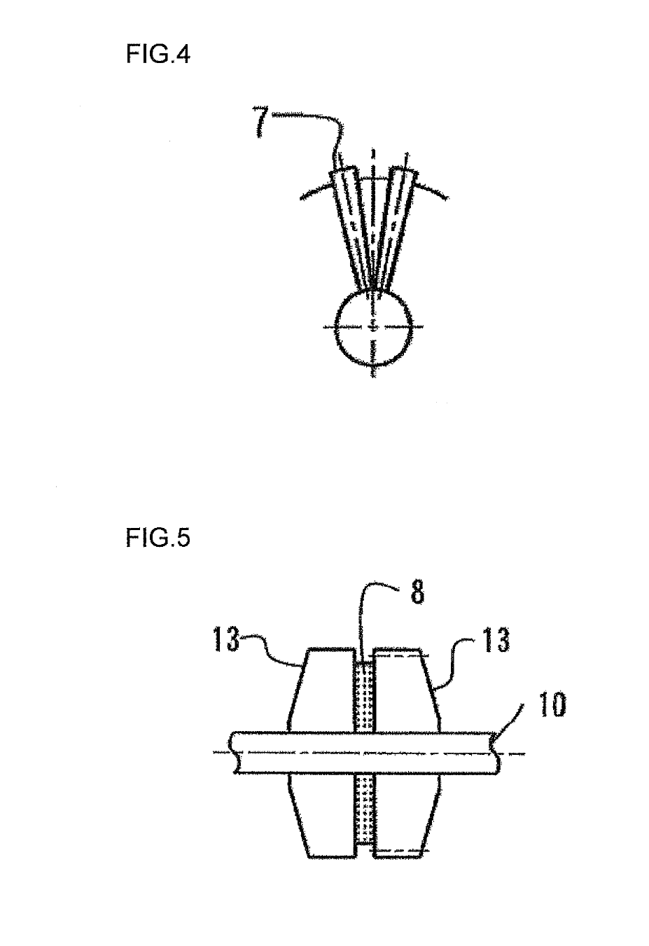

FIG. 2 is a cross-sectional view taken along the line II-II shown in FIG. 1 and showing only the stator core 1. Small teeth are provided in the circumference portion 122 of the distal end portion 121 of the winding pole 120 of the stator core 1 so as to be in parallel with the rotary shaft. As shown in FIG. 1 and FIG. 2, these small teeth are extended in the direction perpendicular to the rotary shaft, so as to be also provided in the end surface portion 123 of the flange-like guide portion 2. FIG. 3 is a view of the rotor core 7 seen from the rotary shaft direction and showing that the teeth of the rotor core 7 are provided in the circumference portion and the side surface portion of the rotor core 7. Note that FIG. 2 is a view showing a winding structure having equally divided six winding poles. However, the number of divisions is not limited to six, and in general, the number of divisions n may be two or more. When the winding is divided in this way, the winding work is easily performed, and the space factor of the winding becomes about 60% or more. In an HBSTM in which the winding is not divided, the space factor of the winding is about 30%, and hence the structure according to the present invention is advantageous for high torque. The stator cores 1 combined with each other are fixed by the bolts 11 so as to be held between the brackets 5 and 6 as shown in FIG. 1. However, the fixation strength between the stator cores 1 may be suitably increased by adhesion or welding of the joining portion formed between the stator cores 1 and extending along the outer circumference portion of the stator cores 1. An example of assembly sequence of the structure shown in FIG. 1 is as follows.

(1) The rotor 200 configured by the rotor core 7 and the permanent magnet 8 is fixed to the rotary shaft 10. Then, spacers 12 are arranged on both sides of the rotor 200, and the brackets 5 and 6 are combined with each other so as to sandwich the rotor 200 together with the spacers.

(2) By using the brackets 5 and 6 and the bearings 9 as guides, six sets of two stator cores 1, which are combined back to back with each other in the rotary shaft direction and around which a winding is wound, are radially inserted from the outer side to the inner side so as to reach concentric guides respectively provided on the brackets 5 and 6.

(3) The brackets 5 and 6, and the stator cores 1 are fixed by the bolts 11. Next, the permanent magnet 8 may be magnetized in the rotary shaft direction.

Next, the structure of the rotor core will be described.

FIG. 4 is a view of the rotor seen from the opposite side in the rotary shaft direction in FIG. 3, and is a view showing that the position of each of the teeth of the rotor core 7, which are the same as the teeth shown in FIG. 3, is arranged by being shifted by ½ pitch.

FIG. 5 is a cross-sectional view showing another rotor 200 of the present invention and including a rotary shaft 10. Reference numeral 13 denotes a rotor core, reference numeral 8 denotes a permanent magnet, and reference numeral 10 denotes the rotary shaft. The end surface of the rotor core 7 shown in FIG. 1 is perpendicular to the rotary shaft 10. However, the end surface of the rotor core 13 is formed like the end surface of an abacus bead, and the teeth the same as the teeth shown in FIG. 3 and FIG. 4 are formed in the outer periphery and the end surface of the rotor core 13. In this case, the end surface portion of a stator core 1 may be formed into an inclined surface corresponding to the end surface of the rotor core 13 so that the teeth of the stator core 1 face the teeth of the rotor core 13.

When the stator core 1 shown in FIG. 2 is manufactured by embossing of the compacted powder, the rotary shaft direction, which is the vertical direction in FIG. 2, is set as the embossing direction. The stator core according to the present invention is configured by combining together two separate core members each having a thickness of half the thickness of the stator core in the rotary shaft direction. A first reason for this is because of the structure for the embossing molding described above. The second reason is because, when the stator core 1 is not divided into two core members in the rotary shaft direction, it is difficult to assemble the stator core 1 with the rotor 200. Further, FIG. 2 shows a three-phase stator structure having six winding poles 120, but the number of winding poles 120 is not limited to six. The present invention can generally be used for a structure of n (two or more) winding poles each having a concentrically wound winding. Further, illustration of the power supply lead is omitted in FIG. 1. Note that the inner rotor type HBSTM is described above with reference to FIG. 1 and FIG. 2, but the present invention can also be applied to an inverted rotor type HBSTM or an outer rotation type HBSTM, in each of which the rotor and the stator are respectively arranged on the outer side and the inner side.

The rotor core 7 of the prior art is made by laminating silicon steel sheets, but the rotor core 7 may be formed of a dust core. In the case of the HBSTM, the magnetic flux of the permanent magnet passes through a part of the rotor and of the stator in the rotary shaft direction. Therefore, even when the permeability of compacted powder is lower than the permeability of silicon steel sheet, it can be expected that the interlinkage magnetic flux of the HBSTM is increased in spite of the lower permeability. In particular, the rotor core used in the present invention has teeth in both the radial direction and the axial direction, and hence the teeth can be manufactured more easily and inexpensively in the case where a dust core or a sintered core is used. As described above, in the case of the HBSTM, its characteristics are equivalent to or better than the characteristics in the case where silicon steel sheets are used. Therefore, from the viewpoint of manufacturing and also the viewpoint of characteristics, it is convenient to adopt a dust core or a sintered core for the rotor core of the present invention.

FIG. 2 shows an example of a case where the stator core of FIG. 1 is configured by split cores made of compacted powder and has six winding poles. In the case where split cores are used, the winding work of the winding is easily performed, and the amount of copper can be increased, so that the winding space factor can be increased to as high as 60% or higher. In the case of an HBSTM having a stator configured by a single body core, the winding space factor is as low as about 30%. The torque generated by a motor is proportional to the square root of copper amount, and hence the torque can be increased to as much as the square root of two times. Further, the torque is determined by the amount of rotor magnetic flux passing through the air gap and the stator winding, that is, by the amount of interlinkage magnetic flux. For this purpose, it is necessary to increase the permeance of the stator and the rotor. In this way, the torque is proportional to the permeance and the area of the teeth facing each other, and is inversely proportional to the air gap. In the HBSTM according to the present invention, the stator faces the rotor in both the radial and axial directions, and hence the entire periphery of the rotor is used for torque generation.

The dust core is manufactured in such a manner that, by mixing soft magnetic iron powder with a small amount of resin as a lubricant or binder, the iron power particles are coated with the resin so that electrical insulation between the iron powder particles is increased to reduce eddy current, and that the mixture is compressed and molded and then sintered. In a rotating electrical machine using the dust core, the core can be formed into a complicated three-dimensional shape, while, in a rotating electrical machine using a core formed by laminating silicon steel sheets, the core has a simple two-dimensional shape. Further, the core formed of the dust core has a characteristic that eddy current loss, which is a part of iron loss, is close to zero. The dust core described above has a disadvantage that the magnetic flux density is lower than that of the core formed by laminating silicon steel sheets. However, the dust core can be made suitable for increasing the efficiency of the rotating electrical machine in such a manner that the dust core is formed into a so-called overhang shape in which the end surface portion of the rotor can be additionally made to face the stator core so as to increase the area in which the stator and the rotor face each other. When the dust core is used, it is possible to easily form the overhang shape, or the like, of the rotating electrical machine, which shape is difficult to be formed by using the method of laminating silicon steel sheets. A sintered core is a metal body which is formed in such a manner that iron powder is pressed and heat-treated at high temperature so that the particles of the iron powder are combined with each other. Unlike the dust core, in the sintered core, the resin binder is not interposed between the particles of the iron powder. Therefore, in the sintered core, the eddy current loss is larger than that of the dust core, but the mechanical strength is larger than that of the dust core. For this reason, the sintered core is used for a rotating electrical machine in which the current frequency and the rotation speed are relatively low. The divided members of the stator core 1 are manufactured by simultaneously compressing and molding the compacted powder using a same mold.

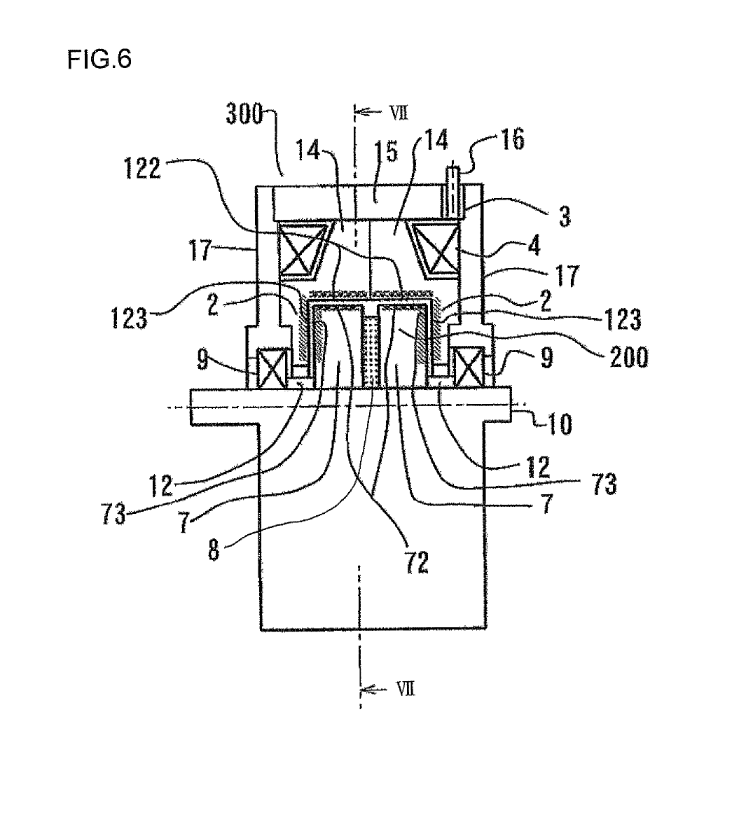

FIG. 6 is an illustration of another example of the rotating machine according to the present invention. Components having the same functions as those of FIG. 1 are denoted by the same reference numerals.

The structure of a stator core 14 according to the present embodiment is the same as the structure shown in FIG. 1 in that two core members having a thickness of half the thickness of the stator core 14 in the rotary shaft direction are combined with each other to form the stator core 14, and in that the teeth of the stator core are made to face the teeth of the rotor core in both the radial and axial directions. The structure of the rotor 200 is the same as that shown in FIG. 1. The structure of the stator core 14 according to the present embodiment is different from the structure shown in FIG. 1 in that an annular yoke portion 15 of the two divided core members of the stator core 14 is formed as one body, that is, in that the portion except the annular yoke portion 15 in the stator core 14 is divided into n portions, and a winding 4 is concentrically wound around a winding pole 120 of each of the n portions. Therefore, the winding pole portion is divided into n portions.

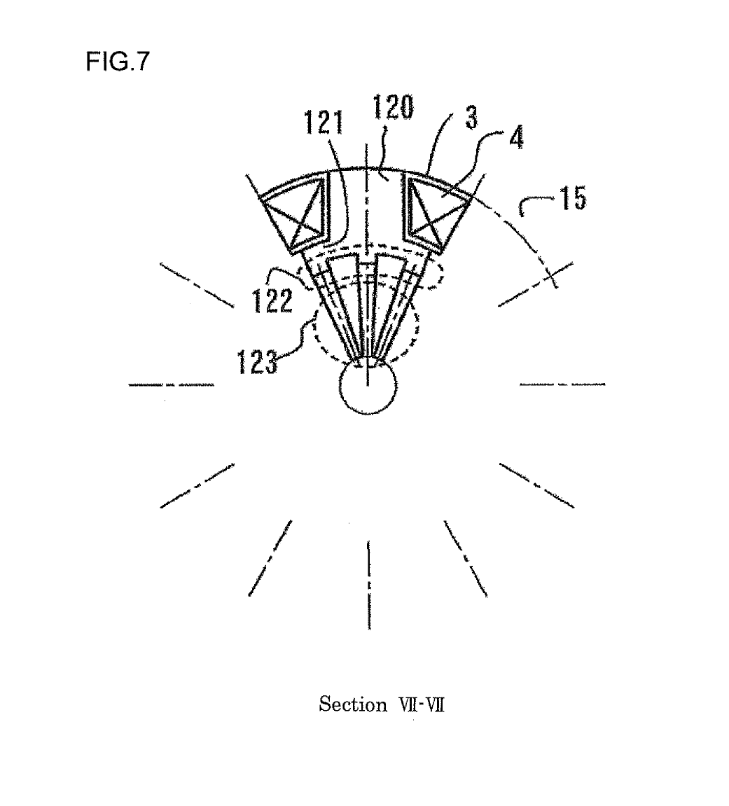

FIG. 7 is a cross-sectional view along the line B-B in FIG. 6, in which the rotating electrical machine in a state where the rotor is removed is seen from the rotary shaft direction. FIG. 7 shows a case where the stator core has six winding poles similarly to the case of FIG. 2. Although the stator core 14 according to the present embodiment is formed of the dust core, the structure of the stator core 14 is further different from the structure shown in FIG. 1 in that a winding body having a winding frame or bobbin, which is denoted by reference numeral 3 and made of an insulator, such as resin, and around which the winding 4 is wound, is prepared in advance so as to be inserted into the stator core. Since with this structure, the winding work of the winding 4 can be performed in the absence of the stator core, the winding work is facilitated and hence the cost of the stator can be correspondingly reduced. The structure of the stator core 14 according to the present embodiment is further different from the structure shown in FIG. 1 in that a tapered surface is formed in the winding groove of the winding pole of the stator core 14 so that the thickness of the groove in the rotary shaft direction is reduced from center to the outer side. A first reason for this is as follows. In the rotating electrical machine having a structure in which the stator winding axis is perpendicular to the rotary shaft 10, when the tapered surface is formed in which the core of the winding portion is configured such that the thickness of the core in the rotary shaft direction is reduced from the center to the outer side, the winding of the radial gap type motor is wound so that the height of the winding end is increased toward the outer side in the radial direction to make the winding end formed to have the same height in the radial direction, and thereby the amount of the copper winding 4 can be increased. This structure cannot be realized by the method of laminating silicon steel sheets, but can be easily realized by the method using the dust core. The second reason for forming the tapered surface in the winding pole of the stator core is because, when the winding body is inserted into the stator core from its outer peripheral portion, the winding body can be easily inserted by the effect of the tapered surface.

An example of assembly sequence of the structure shown in FIG. 6 is as follows.

(1) A rotor 200 configured by a rotor core 7 and a permanent magnet 8 is fixed to a rotary shaft 10. Then, spacers 12 are arranged on both sides of the rotor 200, and brackets 17 are combined with each other so as to sandwich the rotor 200 together with the spacers.

(2) By using the brackets 17 and bearings 9 as guides, six sets of two stator cores 14, which are combined back to back with each other in the rotary shaft direction and around which the winding 4 is wound, are radially inserted from the outer side to the inner side so as to reach concentric guides respectively provided on the brackets 17.

(3) The annular yoke 15 is fitted to the outer periphery of the stator core 14. While a lead 16 is taken out from the annular yoke 15, the brackets 17 are combined with each other and are fixed to each other with screws (not shown) or the like as required. Next, the permanent magnet 8 may be magnetized in the rotary shaft direction.

Note that the inner rotor type HBSTM is described above with reference to FIG. 6 and FIG. 7, but the present invention can also be applied to an inverted rotor type HBSTM or an outer rotation type HBSTM, in each of which the rotor is arranged on the outer side and the stator is arranged on the inner side. Further, the stator core having the tapered winding pole portions may also be applied to the structure shown in FIG. 1.

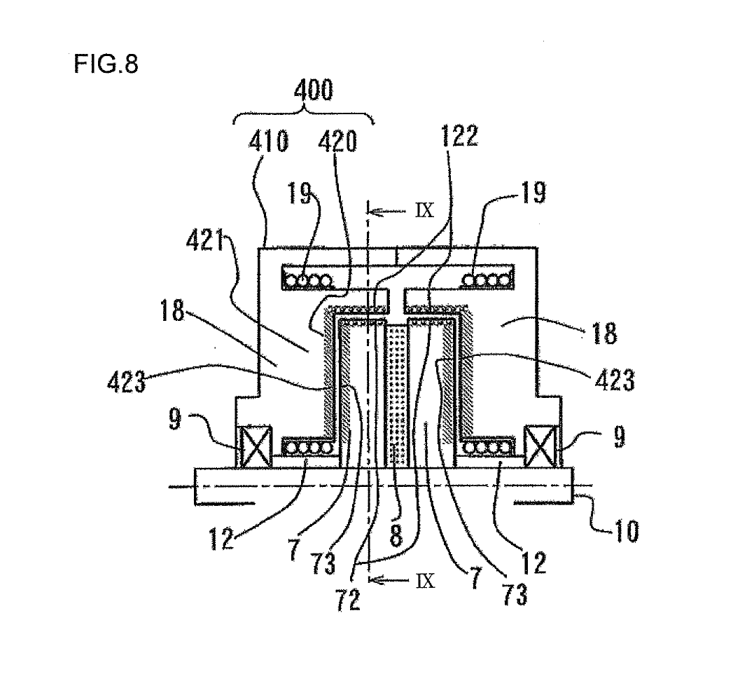

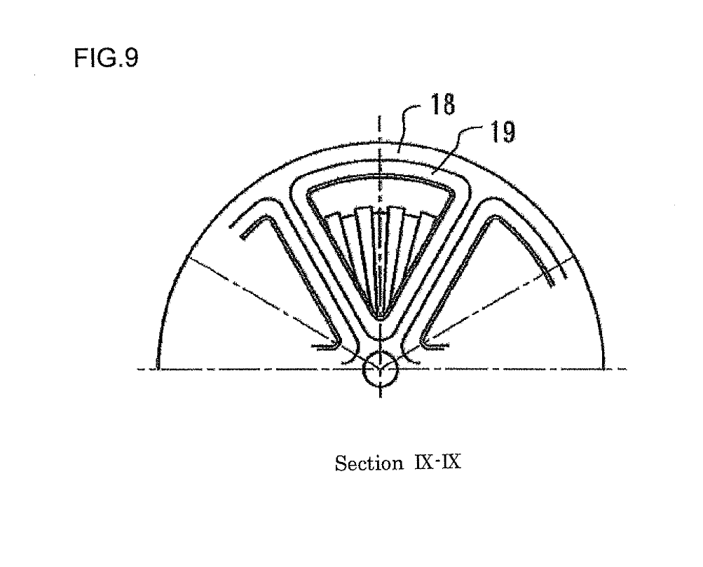

FIG. 8 is a cross-sectional view showing a rotating machine of yet another example of the present invention and including the rotary shaft of the rotating machine. FIG. 9 is a cross-sectional view which is taken along the line IX-IX in FIG. 8, and in which the rotor is removed. FIG. 9 also shows a case where the stator core has six winding poles.

A rotor core 7, a permanent magnet 8, a bearing 9, a rotary shaft 10, and a spacer 12 of a rotating electrical machine according to the present embodiment are the same as those of the rotating electrical machine of FIG. 1 and FIG. 6 described above. Therefore, even in the rotating electrical machine according to the present embodiment, small teeth are provided at predetermined portions of the rotor core and the stator core, and also both the radial gap and the axial gap are provided. That is, the configuration of using the magnetic flux from the entire periphery of the rotor is also applied to the present embodiment similarly to the embodiments shown in FIG. 1 and FIG. 6. Note that, in the illustration of FIG. 8, a rotor 200 is configured by the rotor core 7, the permanent magnet 8, and the rotary shaft 10 as magnetic elements, but the bearing 9 and the spacer 12 are also included in the configuration of the rotating electrical machine.

The embodiment shown in FIG. 8 and FIG. 9 is different from the embodiments shown in FIG. 1 and FIG. 6 in the structure having a winding axis in parallel with the rotary shaft. Further, in the cases shown in FIG. 1 and FIG. 6, the brackets 5, 6 and 17, and the like, made of a nonmagnetic body, such as aluminum material, are needed, but the case shown in FIG. 8 and FIG. 9 is also different from the cases shown in FIG. 1 and FIG. 6 in that a stator core 18 which is a magnetic body of a dust core or a sintered core also serves as a bracket. In FIG. 8 and FIG. 9, the stator core 18 is provided with a winding pole 420 which is projected in the rotary shaft direction and which, as shown in FIG. 9, has approximately fan-shaped teeth radially arranged perpendicularly to the rotary shaft direction. Further, the fan-shaped outer peripheral circular arc portion of the winding pole 420 is further projected in the rotary shaft direction so as to have teeth arranged on the inner peripheral portion thereof and in parallel with the rotary shaft. Further, a winding 19 is wound around the fan-shaped projected portion. The stator core 18 has a cylindrical outer peripheral portion in which the winding 19 is stored. The rotor is held between the two stator cores 18 which are configured in this way and which are brought into close contact with each other at the cylindrical outer peripheral portions thereof. The magnetic path, through which the magnetic flux flows from the N pole to the S pole of the permanent magnet of the rotor, is formed at the close contact portion. In FIG. 8, when the cylindrical outer peripheral portion of the stator core 18 is further covered on the outside with a cylindrical body made of a magnetic or nonmagnetic body, the mechanical strength and the characteristics of the rotating machine can also be improved.

Note that, when the stator core and the rotor core described above are configured by the dust core, it is preferred that the dust core is subjected to one of or both of resin coating treatment and resin impregnation treatment in order to improve the strength and durability thereof. Here, when the treatment is performed, the specific method of the treatment is not limited in particular, and any method can be adopted as long as the method enables the surface of the dust core to be coated with resin and enables resin to be impregnated into the dust core. Specifically, examples of the treatment include electro-deposition coating, electrostatic coating, dipping, and the like. Note that the resin used here is not limited in particular, and various resin can be suitably selected and used. Further, when the dipping is performed, it is possible to use a generally used dipping liquid which contains liquid adhesive or varnish.

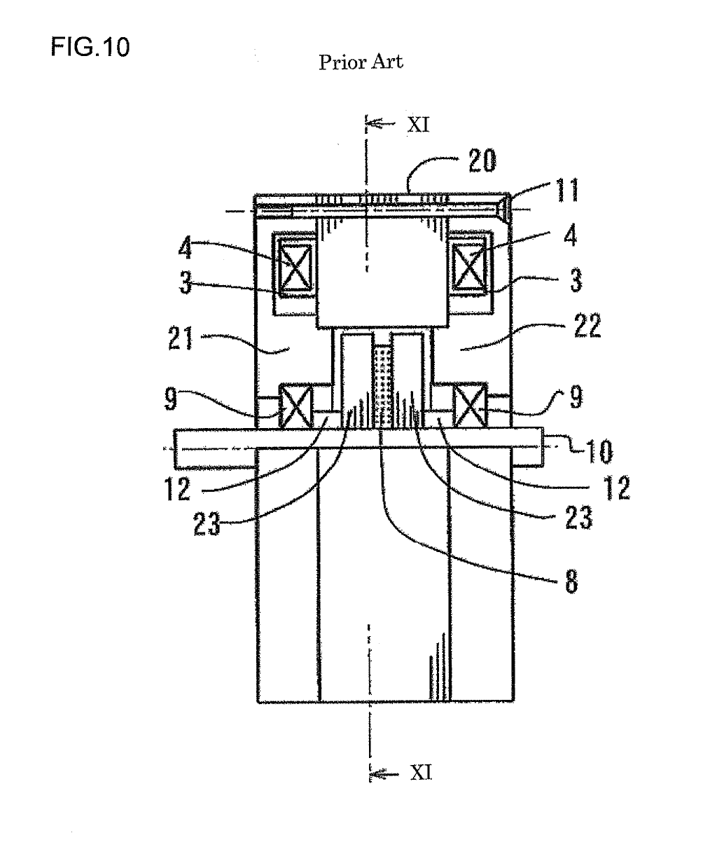

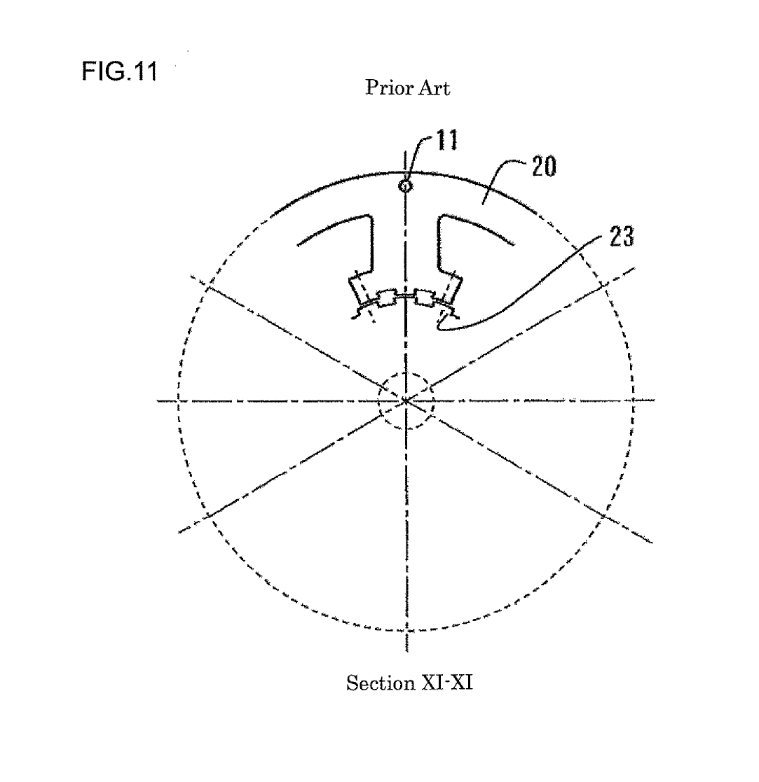

FIG. 10 is a view showing a prior art, and FIG. 11 is a cross-sectional view along the line XI-XI in FIG. 10.

The structure shown in FIG. 10 is different from the structure shown in FIG. 1 in that a stator core denoted by reference numeral 20 is formed by laminating silicon steel sheets and has, on the inner peripheral portion thereof, teeth in parallel with the rotary shaft direction. The configurations of the insulator 3 and the winding 4 are the same as those in the case of FIG. 1. Reference numeral 23 denotes a rotor core which has, on the outer periphery thereof, teeth in parallel with the rotary shaft. That is, FIG. 10 shows a radial gap type rotating machine. Since the radial gap type rotating machine is configured as an HBSTM, the rotor has the same configuration as the configuration in which a permanent magnet 8 is held between the two rotor cores 23 so as to be fixed to the rotary shaft. Reference numerals 21 and 22 denote brackets made of a nonmagnetic body, such as an aluminum material. In the structure configured as described above, the air gap is secured in such a manner that a part of each of the front and rear brackets 21 and 22 is not guided by and fitted to the outer periphery of the stator, but is guided by and directly fitted to a part of the inner peripheral portion of the stator. That is, in this structure, a so-called “inner spigot” structure is adopted. For this reason, in this structure, the length of the rotor 23 in the rotary shaft direction is reduced, and thereby the facing area between the rotor 23 and the stator is reduced, resulting in a problem that it is difficult to obtain high torque. Further, both the brackets are fixed to the stator 20 by bolts 11 penetrating the holes passing through the stator 20, and then two poles are magnetized in the rotary shaft direction, so that the HBSTM is formed. Therefore, the air gap, through which the teeth of the stator face the teeth of the rotor, is only the radial gap, and hence the gap permeance cannot be increased as in the case of the present invention. This results in a problem when high torque is to be obtained as in the case of the present invention. Since an HBSTM motor or a BLDC motor uses a permanent magnet and hence requires no electrical input for field magnetic flux, the motor can be said as a highly efficient rotating electrical machine or generator. However, in recent years, among permanent magnets, the price of a rare-earth magnet, such as a neodymium magnet, having high magnetic energy, has been significantly increased, and hence it is necessary to improve the efficiency of the HBSTM motor or the BLDC motor while reducing the use amount of magnet. As a solution of these problems, the present invention can increase the air gap permeance, and hence is very effective.

The rotating electrical machine according to the present invention can be used for an electric motor or generator and is very practical and suitable for obtaining a less expensive, robust, small and light electric motor or generator, high torque and high efficiency. Therefore, it is expected that the present invention will make a great industrial contribution.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2012-250053 filed on Nov. 14, 2012 including the specification, claims, drawings and summary is incorporated herein by reference in its entirety.

1. A rotating electrical machine including a stator, a rotor, and a rotary shaft, wherein:
the stator is provided with a stator core including an annular yoke portion and n winding poles radially extending from the annular yoke portion, and a winding concentrically wound around each of the winding poles;
a winding axis of the winding is perpendicular to the rotary shaft;
the stator core is divided into two portions each having a thickness substantially half the thickness of the stator core in a rotary shaft direction, and is also circumferentially divided into n portions each including each of the winding poles;
each of the n winding poles includes, at a distal end portion thereof, a circumference portion having small teeth substantially in parallel with the rotary shaft, and an end surface portion having small teeth substantially perpendicular to the rotary shaft;
the rotor includes a permanent magnet magnetized in the rotary shaft direction, and two rotor cores holding the permanent magnet therebetween;
the rotor core includes a circumference portion having small teeth substantially in parallel with the rotary shaft, and an end surface portion having small teeth substantially perpendicular to the rotary shaft;
the circumference portion of the winding pole in the stator and the circumference portion of the rotor core in the rotor face each other via an air gap to provide a radial gap, and the end surface portion of the winding pole in the stator and the end surface portion of the rotor core in the rotor face each other via an air gap to provide an axial gap; and
n is an integer of 2 or more.

2. The rotating electrical machine according to claim 1, wherein:
brackets and bearings are provided on an outer side of the rotor in the rotary shaft direction; and
in a state where the stator core is divided into n portions, the winding is concentrically wound around each of the winding poles, and the divided portions of the stator core are combined and assembled with each other by being inserted from the outer side in the direction perpendicular to the rotary shaft by using the brackets and the bearings as guides.

3. A rotating electrical machine including a stator, a rotor, and a rotary shaft, wherein:
the stator is provided with a stator core including an annular yoke portion and n winding poles radially extending in a state of being in contact with an inner periphery of the annular yoke portion, and a winding concentrically wound around each of the winding poles;
a winding axis of the winding is perpendicular to the rotary shaft;
the stator core is divided, except the annular yoke portion, into two portions each having a thickness substantially half the thickness of the stator core in a rotary shaft direction, and is also circumferentially divided into n portions each including each of the winding poles;
each of the n winding poles includes, at a distal end portion thereof, a circumference portion having small teeth substantially in parallel with the rotary shaft, and an end surface portion having small teeth substantially perpendicular to the rotary shaft;
the rotor includes a permanent magnet magnetized in the rotary shaft direction, and two rotor cores holding the permanent magnet therebetween;
the rotor core includes a circumference portion having small teeth substantially in parallel with the rotary shaft, and an end surface portion having small teeth substantially perpendicular to the rotary shaft;
the circumference portion of the winding pole in the stator and the circumference portion of the rotor core in the rotor face each other via an air gap to provide a radial gap, and the end surface portion of the winding pole in the stator and the end surface portion of the rotor core in the rotor face each other via an air gap to provide an axial gap; and
n is an integer of 2 or more.

4. The rotating electrical machine according to claim 3, wherein:
brackets and bearings are provided on an outer side of the rotor in the rotary shaft direction; and
in a state where the stator core, except the annular yoke portion, is divided into n portions, the winding is concentrically wound around each of the winding poles, and the divided portions of the stator core are combined and assembled with each other in such a manner that the divided portions are assembled from the outer side in the direction perpendicular to the rotary shaft and the annular yoke portion is successively inserted from the rotary shaft direction by using the brackets and the bearings as guides.

5. The rotating electrical machine according to claim 1, wherein the thickness of a groove for winding in the rotary shaft direction, the groove being provided in each of the winding poles of the stator, is reduced from a center toward the outer side of the stator.

6. A rotating electrical machine including a stator, a rotor, and a rotary shaft, wherein:
the stator is provided with two stator cores each including a disk-like yoke portion and n winding poles extending from the disk-like yoke portion in parallel with the rotary shaft, and a winding concentrically wound around each of the winding poles, and is configured by combining the two stator cores with each other in a state where the winding poles face each other in the rotary shaft direction;
a winding axis of the winding is in parallel with the rotary shaft;
each of the two stator cores has a thickness substantially half the thickness of the stator in the rotary shaft direction;
each of the n winding poles includes, at a distal end portion thereof, a circumference portion having small teeth substantially in parallel with the rotary shaft, and an end surface portion having small teeth substantially perpendicular to the rotary shaft;
the rotor includes a permanent magnet magnetized in the rotary shaft direction, and two rotor cores holding the permanent magnet therebetween;
the rotor core includes a circumference portion having small teeth substantially in parallel with the rotary shaft, and an end surface portion having small teeth substantially perpendicular to the rotary shaft;
the circumference portion of the winding pole in the stator and the circumference portion of the rotor core in the rotor face each other via an air gap to provide a radial gap, and the end surface portion of the winding pole in the stator and the end surface portion of the rotor core in the rotor face each other via an air gap to provide an axial gap; and
n is an integer of 2 or more.

7. The rotating electrical machine according to claim 1, wherein the stator core is configured by a dust core or a sintered core.

8. The rotating electrical machine according to claim 1, wherein the rotor core is configured by a dust core or a sintered core.

9. The rotating electrical machine according to claim 7, wherein the dust core or the sintered core configuring one of or both of the stator core and the rotor core is subjected to one of or both of resin coating treatment and resin impregnation treatment.
